(19) United States
(12) Patent Application Publication
(10) Pub. No.: US 2026/0329368 A1
(43) Pub. Date: Oct. 22, 2026

(54) INFORMATION INTERACTION METHOD AND APPARATUS, AND HUMAN-COMPUTER INTERACTION METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Fanchao MENG, Beijing (CN); Liyue JI, Beijing (CN); Yan ZHAO, Beijing (CN); Xiaolin CUI, Beijing (CN); Yang WU, Beijing (CN); Liangyong LUAN, Beijing (CN)

(21) Appl. No.: 19/104,674

(22) PCT Filed: Aug. 16, 2023
(86) PCT No.: PCT/CN2023/113250

§ 371 Date: Feb. 18, 2025

(30) Foreign Application Priority Data
Aug. 18, 2022 (CN) 202210992896.0
Sep. 15, 2022 (CN) 202211131665.7

(51) Int. Cl. G06F 3/01

(52) U.S. Cl. CPC G06F 3/011; G06F 3/016

(57) ABSTRACT

The present disclosure relates to the technical field of computers, in particular to an information interaction method and apparatus, and an electronic device and a storage medium. The information interaction method provided in the embodiments of the present disclosure includes determining a moving end point of a target message, which is sent first, among two or more continuously sent target messages; determining moving end points of the remaining target messages among the two or more target messages on the basis of the moving end point of the target message which is sent first; and on the basis of the determined moving end points of the target messages, sending corresponding target messages.

### CROSS-REFERENCE TO RELATED APPLICATION(S)

The present application is based on and claims priority to Chinese Application Nos. 202210992896.0, filed on Aug. 18, 2022, and 202211131665.7, filed on Sep. 15, 2022, which are incorporated herein by reference in their entireties.

### TECHNICAL FIELD

The present disclosure relates to the field of computer technology and extended reality (XR), and in particular, to an information interaction method and apparatus, an electronic device, and a storage medium, and a human-computer interaction method and apparatus, a device, and a storage medium.

### BACKGROUND

With the development of virtual reality (Virtual Reality, VR) technology, more and more virtual live streaming platforms or applications are developed for users to use. On a virtual live streaming platform, a user can watch a performance of a host through, for example, a head-mounted display device and related accessories, and can interact with the host through expressions, bullet chats, virtual gifts, and the like.

At present, extended reality (XR) technology is used in more and more application scenarios, comprising virtual reality (Virtual Reality, VR), augmented reality (Augmented Reality, AR), mixed reality (Mixed Reality, MR), and the like. In a virtual live streaming scenario, a user can view various virtual live streaming images in an immersive manner through XR technology, for example, the user can experience a real live streaming interactive scene by wearing a head-mounted display (Head Mounted Display, HMD).

Generally, an audience can enhance user interaction in a virtual live streaming scenario by giving likes, commenting, and giving virtual gifts to a favorite host. However, in a virtual live streaming scenario, the audience usually selects a virtual object by emitting a cursor ray, and touches a trigger button of a handle to complete interaction between the user and the host for the virtual object in a virtual space.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to a first aspect, one or more embodiments of the present disclosure provide an information interaction method, comprising:
determining a moving end point of a target message sent firstly in two or more target messages that are sent continuously;
determining a moving end point of the remaining target message in the two or more target messages based on the moving end point of the target message sent firstly; and
sending the two or more target messages based on the determined moving end points of the two or more target messages.

According to a second aspect, one or more embodiments of the present disclosure provide an information interaction apparatus, comprising:
a first end point determining unit configured to determine a moving end point of a target message sent firstly in two or more target messages that are sent continuously;
a second end point determining unit configured to determine a moving end point of the remaining target message in the two or more target messages based on the moving end point of the target message sent firstly; and
a message display unit configured to send the two or more target messages based on the determined moving end points of the two or more target messages.

According to a third aspect, one or more embodiments of the present disclosure provide an electronic device, comprising: at least one memory and at least one processor, where the memory is configured to store program code, and the processor is configured to call the program code stored in the memory to cause the electronic device to perform the information interaction method provided in one or more embodiments of the present disclosure.

According to a fourth aspect, one or more embodiments of the present disclosure provide a non-transitory computer storage medium storing program code that, when executed by a computer device, causes the computer device to perform the information interaction method provided in one or more embodiments of the present disclosure.

According to a fifth aspect, some embodiments of the present disclosure provide a human-computer interaction method applied to an XR device. The method comprises:
determining, in response to a throwing operation on a virtual object in a virtual space, a throwing position of the virtual object in the virtual space; and
presenting a throwing effect of the virtual object in the virtual space based on the throwing position and a designated throwable area in the virtual space.

According to a sixth aspect, some embodiments of the present disclosure provide a human-computer interaction apparatus configured on an XR device. The apparatus comprises:
a throwing position determining module configured to determine, in response to a throwing operation on the virtual object in a virtual space, a throwing position of the virtual object in the virtual space; and
a throwing module configured to present a throwing effect of the virtual object in the virtual space based on the throwing position and a designated throwable area in the virtual space.

According to a seventh aspect, some embodiments of the present disclosure provide an electronic device. The electronic device comprises:
a processor and a memory, where the memory is configured to store a computer program, and the processor is configured to call and run the computer program stored in the memory to perform the human-computer interaction method provided in the fifth aspect of the present disclosure.

According to an eighth aspect, some embodiments of the present disclosure provide a computer-readable storage medium storing a computer program that causes a computer to perform the human-computer interaction method provided in the fifth aspect of the present disclosure.

According to a ninth aspect, some embodiments of the present disclosure provide a computer program product comprising a computer program/instruction that causes a computer to perform the human-computer interaction method provided in the fifth aspect of the present disclosure.

According to a tenth aspect, one or more embodiments of the present disclosure provide a computer program, comprising: instructions that, when executed by a processor, cause the processor to perform the information interaction method or the human-computer interaction method in any one of the foregoing embodiments.

### BRIEF DESCRIPTION OF THE DRAWINGS

The above and other features, advantages, and aspects of the embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic diagram of a virtual reality device according to some embodiments of the present disclosure.

FIG. 2 is a schematic diagram of a virtual field of view of a virtual reality device according to some other embodiments of the present disclosure.

FIG. 3 is a flowchart of an information interaction method according to some embodiments of the present disclosure.

FIG. 4 is a schematic diagram of a virtual reality space according to some embodiments of the present disclosure.

FIG. 5 is a schematic diagram of a virtual reality space according to some other embodiments of the present disclosure.

FIG. 6 is a schematic diagram of a structure of an electronic device according to some embodiments of the present disclosure.

FIG. 7 is a flowchart of a human-computer interaction method according to some embodiments of the present disclosure.

FIG. 8 is a schematic diagram of a structure of a virtual space according to some embodiments of the present disclosure.

FIG. 9A and FIG. 9B are exemplary schematic diagrams of a throwable area in a virtual space according to some embodiments of the present disclosure.

FIG. 10A and FIG. 10B are another exemplary schematic diagrams of a throwable area in a virtual space according to some embodiments of the present disclosure.

FIG. 11 is a flowchart of a method for throwing any virtual object in a virtual space according to some embodiments of the present disclosure.

FIG. 12A is a schematic diagram of an effect in response to a virtual gift being thrown once in a virtual space by a hand model according to some embodiments of the present disclosure.

FIG. 12B is a schematic diagram of an effect in response to a virtual gift being thrown several times continuously in a virtual space by a hand model according to some embodiments of the present disclosure.

FIG. 12C is a schematic diagram of an effect in response to a gift giving prop continuously throwing a virtual gift several times in a virtual space while being held by a hand model according to some embodiments of the present disclosure.

FIG. 13 is an exemplary schematic diagram of a collision between a virtual object and any other virtual object according to some embodiments of the present disclosure.

FIG. 14 is a schematic diagram of canceling holding a virtual object by a hand model to give up throwing according to some embodiments of the present disclosure.

FIG. 15 is a schematic diagram of a human-computer interaction apparatus according to some embodiments of the present disclosure.

FIG. 16 is a schematic block diagram of an electronic device according to some embodiments of the present disclosure.

### DETAILED DESCRIPTION OF EMBODIMENTS

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are only for exemplary purposes, and are not intended to limit the scope of protection of the present disclosure.

It should be understood that the steps described in the implementations of the present disclosure may be performed in different orders, and/or performed in parallel. In addition, the implementations may comprise additional steps and/or omit performing the illustrated steps. The scope of the present disclosure is not limited in this respect.

The term “comprise/comprise” used herein and the variations thereof are an open-ended inclusion, namely, “comprise/comprise but not limited to”. The term “based on” is “at least partially based on”. The term “an embodiment” means “at least one embodiment”; the term “another embodiment” means “at least one another embodiment”; and the term “some embodiments” means “at least some embodiments”. The term “in response to” and related terms mean that one signal or event is affected by another signal or event to a certain extent, but not necessarily completely or directly. If event x occurs “in response to” event y, x may directly or indirectly respond to y. For example, the occurrence of y may eventually lead to the occurrence of x, but there may be other intermediate events and/or conditions. In other cases, y may not necessarily lead to the occurrence of x, and x may occur even if y has not occurred. In addition, the term “in response to” may also mean “at least partially in response to”.

The term “determine” encompasses a wide variety of actions, and may comprise, for example, acquiring, calculating, computing, processing, deriving, investigating, looking up (for example, looking up in a table, a database, or another data structure), ascertaining, and the like, and may also comprise receiving (for example, receiving information), accessing (for example, accessing data in a memory), and the like, as well as resolving, selecting, choosing, establishing, and the like. Related definitions of the other terms will be given in the description below. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that the modifiers should be understood as “one or more” unless the context clearly indicates otherwise.

For the purposes of the present disclosure, the phrase “A and/or B” means (A), (B), or (A and B).

Names of messages or information exchanged between multiple apparatuses in the implementations of the present disclosure are used for illustrative purposes only, and are not used to limit the scope of these messages or information.

The method provided in the embodiments of the present disclosure may be used to send a target message in a virtual reality space, such as an expression, a bullet chat, a gift, and the like. The virtual reality space may be a simulation environment of the real world, a semi-simulated and semi-fictional virtual scene, or a purely fictional virtual scene. The virtual scene may be any one of a two-dimensional virtual scene, a 2.5-dimensional virtual scene, and a three-dimensional virtual scene. The embodiments of the present disclosure do not limit the dimension of the virtual scene. For example, the virtual scene may comprise the sky, land, an ocean, and the like, and the land may comprise environmental elements such as deserts and cities, and a user may control a virtual object to move in the virtual scene.

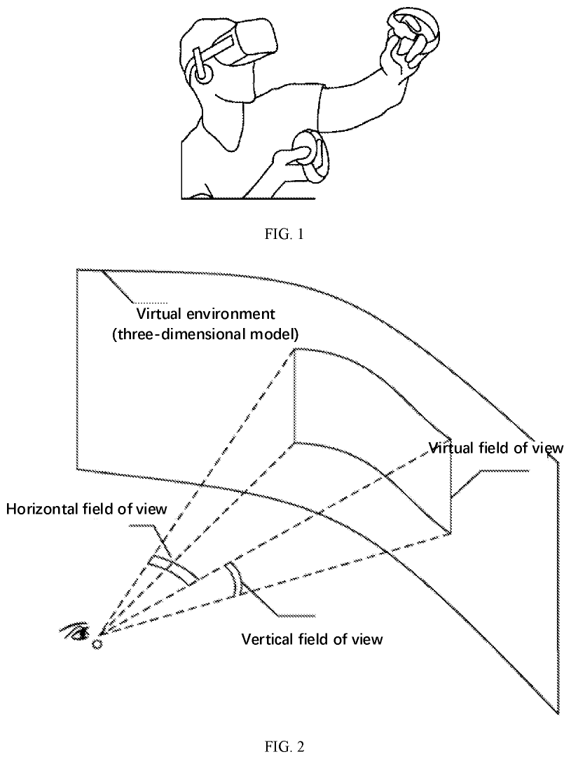

With reference to FIG. 1, a user may enter a virtual reality space through a smart terminal device such as a head-mounted VR glasses, and control his or her own virtual character (Avatar) in the virtual reality space to perform social interaction, entertainment, learning, remote office work, and the like with virtual characters controlled by other users.

In some embodiments, in the virtual reality space, the user may perform a related interaction operation through a controller, and the controller may be a handle. For example, the user performs related operation control through an operation on a button of the handle. Certainly, in other embodiments, the controller may not be used, and a gesture, voice, or multi-modal control method may be used to control a target object in a virtual reality device.

The information interaction method provided in one or more embodiments of the present disclosure uses extended reality (Extended Reality, XR for short) technology. Extended reality technology can combine reality with virtual reality through a computer to provide users with a virtual reality space for human-computer interaction. In the virtual reality space, the user may perform social interaction, entertainment, learning, work, remote office work, create user-generated content (UGC), and the like through a virtual reality device such as a head-mounted display (Head Mount Display, HMD).

The virtual reality device described in the embodiments of the present disclosure may comprise but is not limited to the following types.

A computer-side virtual reality (PCVR) device performs related calculation and data output of a virtual reality function by using a PC side, and an externally connected computer-side virtual reality device uses data output by the PC side to implement a virtual reality effect.

A mobile virtual reality device supports a mobile terminal (such as a smart phone) to be arranged in various manners (such as a head-mounted display provided with a dedicated card slot), and a mobile terminal is connected to the mobile virtual reality device in a wired or wireless manner to perform related calculation of a virtual reality function and output data to the mobile virtual reality device, for example, watch a virtual reality video through an APP of the mobile terminal.

An all-in-one virtual reality device is provided with a processor for performing related calculation of a virtual function, and thus has an independent function of virtual reality input and output, does not need to be connected to a PC side or a mobile terminal, and has high freedom of use.

Certainly, the form implemented by the virtual reality device is not limited to this, and may be further miniaturized or enlarged as required.

The virtual reality device is provided with a sensor (such as a nine-axis sensor) for detecting a posture, which is configured to detect a posture change of the virtual reality device in real time. If a user wears the virtual reality device, when a posture of the user's head changes, a real-time posture of the head is transmitted to a processor, so as to calculate a gaze point of the user's sight in a virtual environment, calculate an image in a three-dimensional model of the virtual environment that is within a gaze range (namely, a virtual field of view) of the user based on the gaze point, and display the image on a display screen, to provide an immersive experience as if the user is watching in a real environment.

FIG. 2 shows a schematic diagram of a virtual field of view of a virtual reality device according to some embodiments of the present disclosure. A horizontal field of view angle and a vertical field of view angle are used to describe a distribution range of the virtual field of view in a virtual environment. A vertical distribution range is represented by a vertical field of view angle BOC, and a horizontal distribution range is represented by a horizontal field of view angle AOB. The human eye can always perceive an image in the virtual field of view in the virtual environment through a lens. It can be understood that a larger field of view angle indicates a larger size of the virtual field of view, and a larger area of the virtual environment that the user can perceive. The field of view angle represents a distribution range of a viewing angle when an environment is perceived through a lens. For example, a field of view angle of a virtual reality device represents a distribution range of a viewing angle of the human eye when a virtual environment is perceived through a lens of the virtual reality device. For another example, for a mobile terminal provided with a camera, a field of view angle of the camera is a distribution range of a viewing angle when the camera perceives a real environment for shooting.

The virtual reality device, for example, the HMD integrates a plurality of cameras (such as a depth camera and an RGB camera), and the camera is not only used for providing a passthrough view. Camera images and an integrated inertial measurement unit (IMU) provide data that can be processed by computer vision methods to automatically analyze and understand the environment. In addition, the HMD is designed to support not only passive computer vision analysis, but also active computer vision analysis. Passive computer vision methods analyze image information captured from the environment. These methods may be monoscopic (images from a single camera) or stereoscopic (images from two cameras). They comprise but are not limited to feature tracking, object recognition, and depth estimation. Active computer vision methods add information to the environment by projecting a pattern that is visible to the camera but not necessarily to the human visual system. Such technologies comprise a time-of-flight (ToF) camera, laser scanning, or structured light to simplify the stereo matching problem. Active computer vision is used to implement scene depth reconstruction.

In some embodiments, the virtual reality space comprises a virtual live streaming space. In the virtual live streaming space, a performer user may perform live streaming in a virtual image or a real image, and an audience user may control a virtual character to watch a live streaming of the performer at a viewing angle such as a first-person viewing angle or a third-person viewing angle.

In some embodiments, a video stream may be obtained, and video content is presented in the virtual reality space based on the video stream. For example, the video stream may use an encoding format such as H.265, H.264, or MPEG-4.

In some embodiments, a client may receive a video live streaming stream sent by a server, and display a video live streaming image in the virtual reality space based on the video live streaming stream.

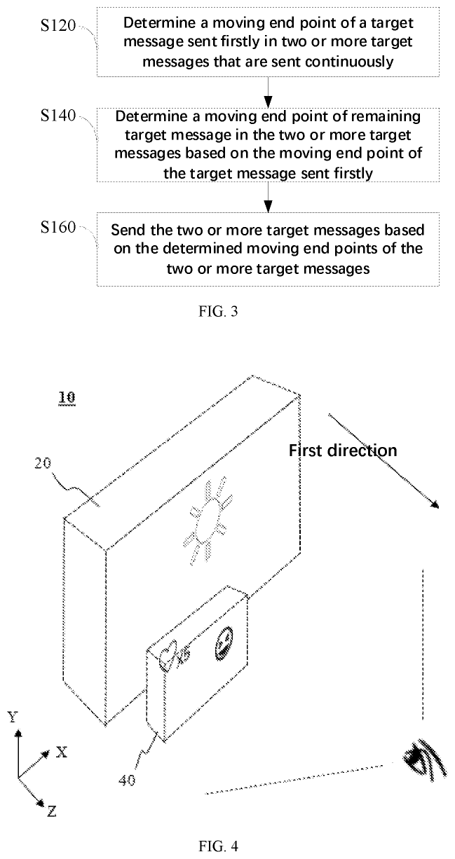

With reference to FIG. 3, FIG. 3 shows a flowchart of an information interaction method 100 according to some embodiments of the present disclosure. The method 100 comprises step S120 to step S160.

Step S120: Determine a moving end point of a target message sent firstly in two or more target messages that are sent continuously.

In some embodiments, the target message comprises but is not limited to a text message (for example, a comment or a bullet chat), and an image message (for example, an emoji, a picture, a virtual item, or the like).

In some embodiments, the target message may be a custom message edited by a user, a message provided by a system and selected by the user through a message sending operation, a message associated with the message sending operation, or a message randomly assigned by the system in response to the message sending operation.

The message sending operation comprises but is not limited to a somatosensory control operation, a gesture control operation, an eyeball shaking operation, a touch operation, a voice control instruction, or an operation on an external control device (for example, a button operation).

In some embodiments, the user may call up a message editing interface through a preset operation, select a candidate target message, or edit a custom target message, send the target message on the message editing interface, and display, in the virtual reality space, the target message sent by the current user.

In some embodiments, the user may select an existing candidate target message, or edit a custom target message, send the target message on a message editing interface displayed in the virtual reality space, and display, in a target message display space, the target message sent by the current user. The target message display space is an area in the virtual reality space for displaying the target message. For example, the message editing interface may be displayed in the virtual reality space in advance, or may be called up based on a preset operation. The message editing interface may be used to edit a target message, or may be used to directly display one or more preset candidate target messages for a user to directly select. For example, the message editing interface may be a message panel (for example, an expression panel).

In some embodiments, the message editing interface may be an area preset in the virtual reality space for displaying one or more candidate target messages.

In some other embodiments, the message sending operation may comprise a preset operation performed by the user on a virtual reality control device, for example, triggering a preset button of the virtual reality control device (for example, a handle). For example, the preset button may be associated with a preset target message. In response to the user triggering the preset button, the target message may be sent; or in response to the user triggering the preset button, the system randomly assigns a target message for this trigger.

In some embodiments, the user may continuously trigger N message sending operations to continuously send N target messages, and an interval between two adjacent first message sending operations does not exceed a preset time interval. For example, the user may continuously trigger a preset button of a virtual reality control device (for example, a handle) for N times, or click a candidate target message displayed on a message panel for N times continuously, and ensure that an interval between each trigger/click does not exceed the preset time interval, so that N target messages may be sent continuously.

Step S140: Determine a moving end point of the remaining target message in the two or more target messages based on the moving end point of the target message sent firstly.

The remaining target message in the two or more target messages is a target message other than the target message sent firstly.

In some embodiments, it is assumed that the user sequentially triggers message sending operations A, B, C, and D in sequence. A time interval between the message sending operations A and B is greater than a preset time interval, and time intervals between the message sending operations B and C and between the message sending operations C and D are not greater than the preset time interval. In this case, the message sending operations B, C, and D may be determined as operations for continuously sending two or more target messages, a target message b sent by the message sending operation B is used as the target message sent firstly, a moving end point of the target message b is determined, and moving end points of a target message c and a target message d sent by the message sending operations C and D are determined based on the determined moving end point of the target message b.

In some embodiments, when the user triggers a first message sending operation, if it is determined that a time interval between the first message sending operation and a previous message sending operation exceeds the preset time interval, a moving end point of a first target message sent by the first message sending operation is determined in response to the first message sending operation. If the user triggers a second message sending operation within the preset time interval after the first message sending operation is triggered, a moving end point of a second target message sent by the second message sending operation is determined based on the moving end point of the first target message. Similarly, if the user triggers a third message sending operation within the preset time interval after the second message sending operation is triggered, a moving end point of a second target message sent by the third message sending operation is determined based on the moving end point of the first target message.

In some other embodiments, the user may also directly and continuously send a preset number of target messages through a preset message continuous sending instruction.

Step S160: Send a corresponding target message based on the determined moving end point of the target message.

In some embodiments, the target message may move in the virtual reality space toward a corresponding moving end point. For example, in the two or more target messages that are sent continuously, the target message sent firstly moves toward the moving end point determined in step S120, and the remaining target message moves toward the moving end points determined in step S140.

It should be noted that a moving start point of the target message may be located at any position in the virtual reality space, or may be located at a preset specific position, or may be a position determined based on a corresponding message sending operation. This is not limited in the present disclosure. In addition, a moving path of the target message may be a straight line, a curve, or another shape. This is not limited in the present disclosure either.

According to one or more embodiments of the present disclosure, by determining a moving end point of the remaining target message in the two or more target messages based on the moving end point of the target message sent firstly, diversity and consistency of the continuously sent messages can be balanced, so that the continuously sent messages can be identified and distinguished, and efficiency of determining the moving end points of the continuously sent messages can also be improved.

In some embodiments, a moving end point may be randomly assigned to the target message sent firstly in N target messages that are sent continuously. For example, a target message display space for displaying a target message may be set in the virtual reality space, and the moving end point of the target message sent firstly may be randomly determined in the target message display space.

In some embodiments, there is a preset position relationship between the moving end point of the remaining target message and the moving end point of the target message sent firstly. For example, a distance between the moving end point of the remaining target message and the moving end point of the target message sent firstly may not exceed a preset threshold, or the moving end point of the remaining target message may be located in a preset area (for example, a circular area, a square area, a spherical area, or a cube area) centered on the moving end point of the target message sent firstly.

In some embodiments, the moving end point of the remaining target message is randomly determined in the preset area centered on the moving end point of the target message sent firstly. In this way, the continuously sent messages can be concentrated and randomly displayed around the first continuously sent message, diversity and consistency of the continuously sent messages can be further balanced, and a visual effect that the continuously sent messages are randomly scattered can be presented.

For example, a corresponding moving end point may be randomly assigned to the remaining target message in a sphere centered on the moving end point of the target message sent firstly and having a radius of a preset length.

In some embodiments, the method 100 further comprises:

Step S170: Display an order identifier indicating a sending order of the first target message in the two or more target messages at a preset position of the first target message after the first target message moves to the determined moving end point.

The first target message may be any one of the two or more target messages.

In this embodiment, by displaying, at a preset position of the first target message, an order identifier indicating a sending order of the first target message in the two or more target messages, an order and a quantity of the continuously sent information can be displayed in sequence, so that the continuously sent messages can be easily identified.

For example, the order identifier may be located above, below, to the left of, or to the right of the corresponding first target message, but the present disclosure is not limited thereto.

In some embodiments, a duration for which the order identifier is continuously displayed does not exceed a duration for which the first target message is continuously displayed at the moving end point position. In this embodiment, by setting the duration for which the order identifier is continuously displayed to not exceed the duration for which the first target message is continuously displayed at the moving end point position, it is prevented that the duration for which the order identifier is continuously displayed is too long, thereby occupying a display space of the continuously sent messages.

In some embodiments, the method 100 further comprises:

Step S180: Display a user identifier indicating sender information of the target message at a preset position of the target message during a sending process of the target message and/or after the target message moves to the determined moving end point.

In this embodiment, by displaying the corresponding user identifier at the preset position of the target message during the sending process of the target message and/or after the target message moves to the determined moving end point, a sender of the target message can be reflected more intuitively and conveniently.

For example, the user identifier comprises but is not limited to a user avatar, a user nickname, and a user identifier.

For example, the user identifier may be located above, below, to the left of, or to the right of the corresponding first target message, but the present disclosure is not limited thereto.

In some embodiments, there are different preset position relationships between different types of target messages and the user identifier. For example, in response to the target message being an image of a solid or opaque object, the corresponding user identifier may be displayed outside the image of the solid or opaque object. In response to the target message being an image of a hollow or transparent object, the corresponding user identifier may be displayed inside the image of the hollow or transparent object.

In this embodiment, by setting a position relationship between the target message and the corresponding user identifier based on a visualization type of the target message, display diversity and display fit between the user identifier and the target message can be improved, thereby improving user experience.

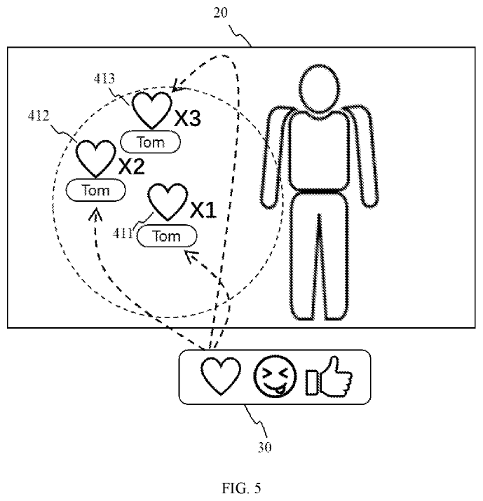

With reference to FIG. 4 and FIG. 5, a virtual reality space 10 comprises a video image display space 20 and a target message display space 40. The video image display space 20 may be used to display a video image, for example, a live streaming image. The virtual reality space further comprises a message editing interface 30 on which a plurality of candidate target expressions are displayed for a user to select. In response to the user selecting a target expression 421, the target expression 421 may move to the target message display space from a position on the message editing interface 30. In response to the user continuously triggering a heart-shaped expression displayed in the message editing interface 30 three times, target expressions 411, 412, and 413 may move to the target message display space 40 in succession along a curved path from a position on the message editing interface 30. The target expressions 412 and 413 finally move to a spherical area centered on the target expression 411. Order identifiers “×1”, “×2”, and “×3” are respectively displayed on the right sides of the target expressions 411, 412, and 413, representing that the target expression 411 is an expression that is first sent in the continuously sent expressions, the target expression 412 is an expression that is second sent in the continuously sent expressions, and the target expression 413 is an expression that is third sent in the continuously sent expressions. A user identifier “Tom” of a sender is displayed below each target expression.

In some embodiments, the method 100 further comprises:

Step S191: Display a first effect associated with the target message during a process in which the target message moves to a corresponding moving end point; and/or

Step S192: Display a second effect associated with the target message after the target message moves to the corresponding moving end point.

For example, the first effect may be a rotation effect of the target message, and the second effect may be a deformation effect of the target message. However, the present disclosure is not limited thereto.

In this embodiment, by displaying the first effect associated with the target message during the process in which the target message moves to the corresponding moving end point, and displaying the second effect associated with the target message after the target message moves to the corresponding moving end point, a display form of a target message sending process can be enriched, and user experience can be improved.

Correspondingly, according to some embodiments of the present disclosure, there is provided an information interaction apparatus, comprising:
a first end point determining unit configured to determine a moving end point of a target message sent firstly in two or more target messages that are sent continuously;
a second end point determining unit configured to determine a moving end point of the remaining target message in the two or more target messages based on the moving end point of the target message sent firstly; and
a message display unit configured to send a corresponding target message based on the determined moving end point of the target message.

In some embodiments, determining the moving end point of the target message sent firstly comprises: randomly determining the moving end point of the target message sent firstly in a target message display space set in a virtual reality space.

In some embodiments, there is a preset position relationship between the moving end point of the remaining target message and the moving end point of the target message sent firstly.

In some embodiments, the message display unit is configured to randomly determine the moving end point of the remaining target message in a preset area centered on the moving end point of the target message sent firstly.

In some embodiments, the information interaction apparatus further comprises:
a first identifier unit configured to display an order identifier indicating a sending order of a first target message in the two or more target messages at a preset position of the first target message after the first target message moves to the determined moving end point.

In some embodiments, a duration for which the order identifier is continuously displayed does not exceed a duration for which the first target message is continuously displayed at the moving end point position.

In some embodiments, the information interaction apparatus further comprises:
a second identifier unit configured to display a user identifier indicating sender information of the target message at a preset position of the target message during a sending process of the target message and/or after the target message moves to the determined moving end point.

In some embodiments, there are different preset position relationships between different types of target messages and the user identifier.

In some embodiments, the information interaction apparatus further comprises: an effect unit configured to display a first effect associated with the target message during a process in which the target message moves to a corresponding moving end point; and/or display a second effect associated with the target message after the target message moves to the corresponding moving end point.

For some embodiments of the apparatus, since it basically corresponds to an embodiment of the method, reference may be made to the related parts of the embodiment of the method for the related parts. The apparatus embodiments described above are merely illustrative, and the modules described as separate parts may or may not be physically separate. Some or all of the modules may be selected according to actual needs to achieve the objectives of the solutions of the embodiments. A person of ordinary skill in the art may understand and implement the embodiments without creative efforts.

Correspondingly, according to one or more embodiments of the present disclosure, there is provided an electronic device, comprising:
at least one memory and at least one processor, where
the memory is configured to store program code, and the processor is configured to call the program code stored in the memory to cause the electronic device to perform the information interaction method provided in one or more embodiments of the present disclosure.

Correspondingly, according to one or more embodiments of the present disclosure, there is provided a non-transitory computer storage medium storing program code that, when executed by a computer device, causes the computer device to perform the information interaction method provided in one or more embodiments of the present disclosure.

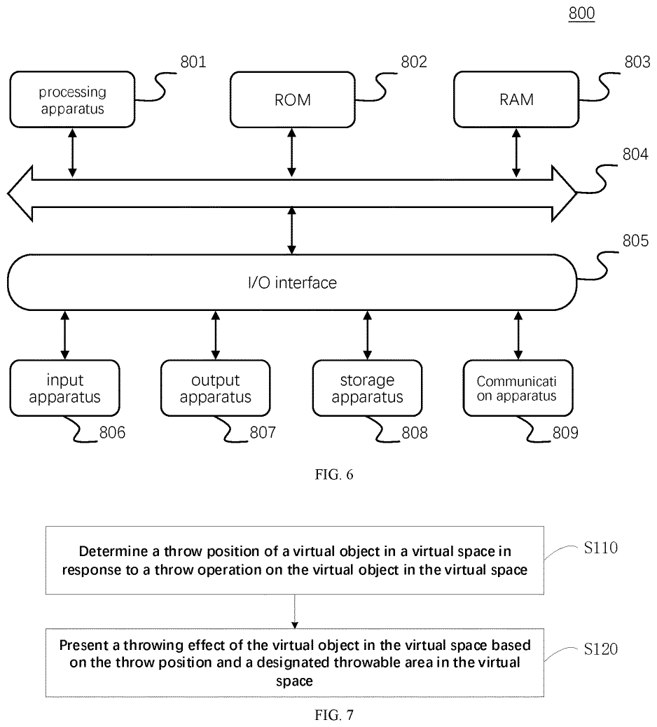

With reference to FIG. 6 below, FIG. 6 shows a schematic diagram of a structure of an electronic device (for example, a terminal device or a server) 800 suitable for implementing the embodiments of the present disclosure. The terminal device in the embodiments of the present disclosure may comprise but is not limited to mobile terminals such as a mobile phone, a notebook computer, a digital broadcast receiver, a personal digital assistant (PDA), a tablet computer (PAD), and a portable multimedia player (PMP), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 800 may comprise a processing apparatus (for example, a central processing unit, a graphics processing unit, etc.) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 comprising, for example, a touch screen, a touchpad, a keyboard, a mouse, a camera, a microphone, an accelerometer, and a gyroscope; an output apparatus 807 comprising, for example, a liquid crystal display (LCD), a speaker, and a vibrator; the storage apparatus 808 comprising, for example, a tape and a hard disk; and a communication apparatus 809. The communication apparatus 809 may allow the electronic device 800 to perform wireless or wired communication with other devices to exchange data. Although FIG. 6 shows the electronic device 800 having various apparatuses, it should be understood that it is not required to implement or have all of the shown apparatuses. It may be an alternative to implement or have more or fewer apparatuses.

In particular, according to some embodiments of the present disclosure, the process described above with reference to the flowcharts may be implemented as a computer software program. For example, this embodiment of the present disclosure comprises a computer program product, which comprises a computer program carried on a computer-readable medium, where the computer program comprises program code for performing the method shown in the flowchart. In such an embodiment, the computer program may be downloaded from a network through the communication apparatus 809 and installed, installed from the storage apparatus 808, or installed from the ROM 802. When the computer program is executed by the processing apparatus 801, the above functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. Examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may comprise a data signal propagated in a baseband or as a part of a carrier, where the data signal carries computer-readable program code. The propagated data signal may be in various forms, comprising but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, comprising but not limited to: electric wires, optical cables, radio frequency (RF), and the like, or any suitable combination thereof.

In some implementations, a client and a server may communicate using any currently known or future-developed network protocol such as a HyperText Transfer Protocol (HTTP), and may be connected to digital data communication (for example, a communication network) in any form or medium. Examples of the communication network comprise a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device; or may exist independently without being assembled into the electronic device.

The above computer-readable medium carries one or more programs that, when executed by the electronic device, cause the electronic device to perform the method of the present disclosure described above.

The computer program code for performing the operations of the present disclosure may be written in one or more programming languages or a combination thereof, where the programming languages comprise object-oriented programming languages such as Java, Smalltalk, and C++, and further comprise conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of a remote computer, the remote computer may be connected to a computer of a user through any kind of network, comprising a local area network (LAN) or a wide area network (WAN), or may be connected to an external computer (for example, connected through the Internet using an Internet service provider).

The flowcharts and block diagrams in the accompanying drawings illustrate the possibly implemented system architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments described in the present disclosure may be implemented by means of software, or may be implemented by means of hardware. The name of a unit does not constitute a limitation on the unit itself in some cases.

The functions described herein above may be performed at least partially by one or more hardware logic components. For example, without limitation, exemplary types of hardware logic components that may be used comprise: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may comprise but is not limited to electronic, magnetic, optical, electromagnetic, infrared, or semiconductor systems, apparatuses, or devices, or any suitable combination thereof. Examples of the machine-readable storage medium may comprise an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, there is provided an information interaction method, comprising: determining a moving end point of a target message sent firstly in two or more target messages that are sent continuously; determining a moving end point of the remaining target message in the two or more target messages based on the moving end point of the target message sent firstly; and sending a corresponding target message based on the determined moving end point of the target message.

According to one or more embodiments of the present disclosure, determining the moving end point of the target message sent firstly comprises: randomly determining the moving end point of the target message sent firstly in a target message display space set in a virtual reality space.

According to one or more embodiments of the present disclosure, there is a preset position relationship between the moving end point of the remaining target message and the moving end point of the target message sent firstly.

According to one or more embodiments of the present disclosure, the determining a moving end point of the remaining target message in the two or more target messages based on the moving end point of the target message sent firstly comprises: randomly determining the moving end point of the remaining target message in a preset area centered on the moving end point of the target message sent firstly.

The information interaction method according to one or more embodiments of the present disclosure further comprises: displaying an order identifier indicating a sending order of the first target message in the two or more target messages at a preset position of the first target message after the first target message moves to the determined moving end point.

According to one or more embodiments of the present disclosure, a duration for which the order identifier is continuously displayed does not exceed a duration for which the first target message is continuously displayed at the moving end point position.

The information interaction method according to one or more embodiments of the present disclosure further comprises: displaying a user identifier indicating sender information of the target message at a preset position of the target message during a sending process of the target message and/or after the target message moves to the determined moving end point.

According to one or more embodiments of the present disclosure, there are different preset position relationships between different types of target messages and the user identifier.

The information interaction method according to one or more embodiments of the present disclosure further comprises: displaying a first effect associated with the target message during a process in which the target message moves to a corresponding moving end point; and/or displaying a second effect associated with the target message after the target message moves to the corresponding moving end point.

According to one or more embodiments of the present disclosure, there is provided an information interaction apparatus, comprising: a first end point determining unit configured to determine a moving end point of a target message sent firstly in two or more target messages that are sent continuously; a second end point determining unit configured to determine a moving end point of the remaining target message in the two or more target messages based on the moving end point of the target message sent firstly; and a message display unit configured to send a corresponding target message based on the determined moving end point of the target message.

According to one or more embodiments of the present disclosure, there is provided an electronic device, comprising: at least one memory and at least one processor, where the memory is configured to store program code, and the processor is configured to call the program code stored in the memory to cause the electronic device to perform the information interaction method provided in one or more embodiments of the present disclosure.

According to one or more embodiments of the present disclosure, there is provided a non-transitory computer storage medium storing program code that, when executed by a computer device, causes the computer device to perform the information interaction method provided in one or more embodiments of the present disclosure.

The foregoing description is merely preferred embodiments of the present disclosure and an illustration of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features with similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are comprised in the foregoing discussions, these details should not be construed as limiting the scope of the present disclosure. Some features that are described in the context of separate embodiments may alternatively be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter specified in the appended claims is not necessarily limited to the specific features or actions described above. In contrast, the specific features and actions described above are merely exemplary forms of implementing the claims.

As described above, in a virtual live streaming scenario, it is impossible to ensure the interactivity and interest of a virtual object in a virtual space.

The present disclosure provides a human-computer interaction method and apparatus, a device, and a storage medium, to ensure the intuitiveness and interest of interaction of a virtual object in a virtual space, and to motivate the enthusiasm for live streaming in the virtual space.

In order to solve the problem that in response to any virtual object being thrown to a streamer in a virtual space, the intuitiveness of interaction of the virtual object in the virtual space cannot be ensured, the technical solution of the present disclosure comprises: Pre-designating a throwable area in the virtual space. Furthermore, in response to any virtual object being thrown in the virtual space, a throw position of the virtual object is first determined. Then, a throwing effect of the virtual object is presented in the virtual space based on the throw position and the designated throwable area, thereby ensuring the intuitiveness and accuracy of throwing the virtual object in the virtual space, and enhancing the interactivity and interest of the virtual object and a user interaction atmosphere in the virtual space.

FIG. 7 is a flowchart of a human-computer interaction method according to some embodiments of the present disclosure. The method may be applied to an XR device, but is not limited thereto. The method may be performed by a human-computer interaction apparatus provided in the present disclosure, where the human-computer interaction apparatus may be implemented in any software and/or hardware manner. For example, the human-computer interaction apparatus may be configured in an electronic device such as an AR/VR/MR device that can simulate a virtual scene, and the present disclosure does not impose any limitation on a specific type of the electronic device.

In some embodiments, as shown in FIG. 7, the method may comprise the following steps:

S710: Determine a throw position of a virtual object in a virtual space in response to a throw operation on the virtual object in the virtual space.

In the present disclosure, the virtual space may be a corresponding virtual environment simulated by an XR device for any live streaming scene selected by a user, to display corresponding live streaming interaction information in the virtual space. For example, a streamer is supported to select a specific type of live streaming scene to construct a corresponding virtual live streaming environment, as the virtual space in the present disclosure, so that viewers can enter the virtual space to implement corresponding live streaming interaction.

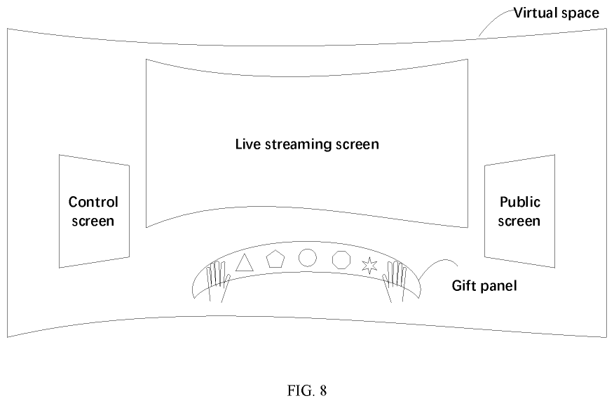

In the virtual space, a plurality of virtual screens such as a live streaming screen, a control screen, and a public screen may be separately set for different live streaming functions, to display different live streaming content. As shown in FIG. 8, a live streaming video stream at a streamer end may be displayed on the live streaming screen, so that a user can watch a corresponding live streaming picture. Information such as streamer information, online viewer information, a related live streaming recommendation list, and a current live streaming definition option may be displayed on the control screen, to facilitate the user to perform related live streaming operations. Information such as various user comment information, likes, and gift giving in the current live streaming may be displayed on the public screen, to facilitate the user to perform related management on the current live streaming.

It should be understood that the live streaming screen, the control screen, and the public screen are all displayed at different positions in the virtual space and face the user. In addition, a position and a style of any virtual screen may be adjusted to prevent the virtual screen from blocking another virtual screen.

For example, in response to a virtual object thrown by the user being a virtual gift, a corresponding gift entry is displayed in the virtual space. In response to a user wanting to give a virtual gift to a streamer, the user first triggers the gift entry, for example, selects the gift entry by using a handle cursor, or clicks the gift entry by using a hand model. Therefore, after a trigger operation on the gift entry is detected, a corresponding gift panel is displayed in the virtual space. The gift panel displays a plurality of virtual gifts of different types to the user, so that the user can independently select a specific virtual gift in some embodiments to give to the streamer.

In the virtual space, any virtual object may be selected in the virtual space by using the handle cursor or the hand model. Then, the present disclosure may detect in real time whether the user performs a corresponding throw operation on the selected virtual object, to determine whether the virtual object needs to be thrown into the virtual space.

After detecting a throw operation on any virtual object in the virtual space, the present disclosure first analyzes a presentation form of the virtual object in response to the virtual object being thrown to a streamer in the virtual space, to determine a final position that can be reached by the virtual object in response to the virtual object being thrown into the virtual space, as the throw position in the present disclosure.

S720: Present a throwing effect of the virtual object in the virtual space based on the throw position and a designated throwable area in the virtual space.

According to the technical solution of the present disclosure, in response to a throw operation on any virtual object in the virtual space, a throw position of the virtual object in the virtual space is first determined. Then, a throwing effect of the virtual object is presented in the virtual space based on the throw position and a designated throwable area in the virtual space, thereby ensuring the intuitiveness and accuracy of throwing the virtual object in the virtual space, and enhancing the interactivity and interest of the virtual object and a user interaction atmosphere in the virtual space, and motivating the enthusiasm for live streaming of users in the virtual space.

It is considered that in response to the user facing the live streaming screen in the virtual space to watch a live streaming video stream of a streamer, there are usually a corresponding visible area and a blind area. There may also be some virtual objects in the virtual space, such as a control screen, a public screen, a gift panel, etc., which may also block the sight of the user for watching the live streaming video stream. Moreover, for a throwing effect in the virtual space, the throwing effect usually needs to be presented between the user and the live streaming video stream of the streamer (that is, the live streaming screen), so that the user can watch the throwing effect, to determine whether the virtual object is successfully thrown. In response to a virtual object being thrown in the virtual space but the user cannot watch a throwing effect of the virtual object, interaction between the user and the streamer for the virtual object cannot be ensured.

Therefore, in order to ensure that the user can watch an interactive effect presented after any virtual object is thrown in the virtual space, the present disclosure may pre-designate a throwable area of a virtual object in the virtual space based on a position where the user is located in the virtual space and a position of the live streaming screen, so that for a virtual gift that falls in the throwable area after being thrown, the user can be ensured to watch a corresponding throwing effect.

After the throw position of any virtual object in the virtual space is determined, whether the throw position is located in the designated throwable area in the virtual space is determined, to determine whether the current throw can be successfully performed. Furthermore, in response to it being determined that the virtual object can be thrown into the throwable area in the virtual space, it indicates that the current throw can be successfully performed, that is, the throwing effect of the virtual object can be presented in the virtual space.

As some embodiments in the present disclosure, the present disclosure may determine the throwable area in the virtual space based on a user visible area in the virtual space and a preset throwable range.

In other words, the present disclosure may determine a visible area of the user facing the live streaming screen based on a relative position relationship between a position where the user is located in the virtual space and a position of the live streaming screen. In addition, because the visible area of the user is relatively large, to ensure that an effect of the virtual object being thrown to the streamer is presented in a focused manner, the present disclosure may further set a throwable range, for example, an angular range of 0 to 170 degrees in response to the user facing the live streaming screen. Then, a coincident area between the user visible area and the preset throwable range is determined, and the throwable area in the virtual space can be determined. Furthermore, an area other than the throwable area in the virtual space may be used as a non-throwable area in the virtual space.

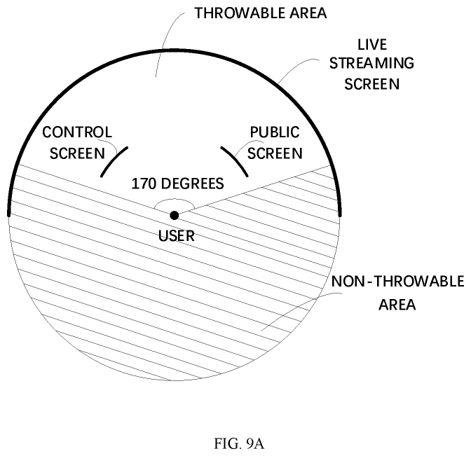

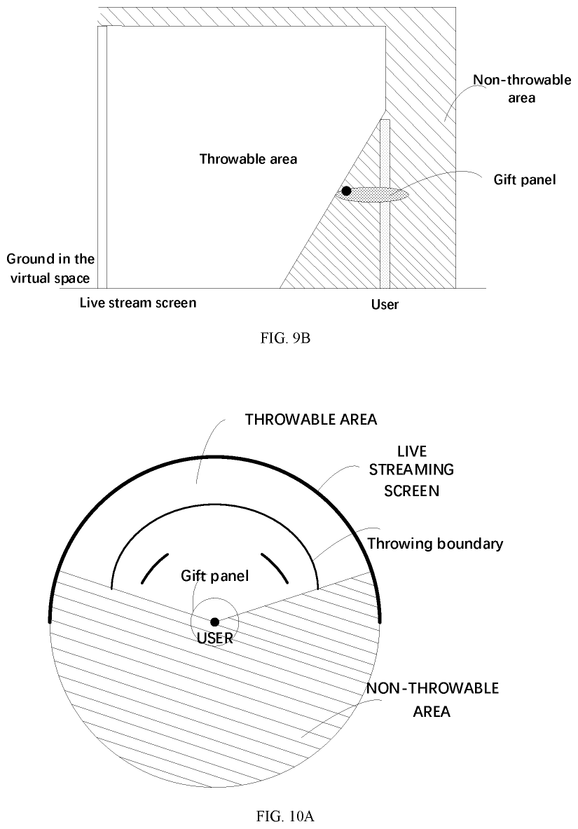

For example, the thrown virtual object is any virtual gift, as shown in a top view in FIG. 9(A), in response to the virtual space being represented as a circle, it is assumed that the user is located at a center point of the virtual space. Because a throwing effect of any virtual object is presented between the user and the live streaming screen where the streamer is located, the live streaming screen may be used as an outer boundary of the virtual space, where the outer boundary comprises the control screen and the public screen. Then, the present disclosure may set an area within 170 degrees when the user faces the live streaming screen as the throwable area in the present disclosure, and set other areas as non-throwable areas.

As shown in a side view in FIG. 9(B), because of the gift panel being presented close to the user, a part of sight of the user downward is blocked, an area where the sight is blocked by the gift panel also belongs to the non-throwable area. In other words, visual blind areas and sight-blocked areas such as a top, a bottom, and a rear of the user in the virtual space are all set as the non-throwable areas in the virtual space.

For example, considering that the virtual space is large and a distance between the user and the live streaming screen may also be large, in response to a corresponding throwing effect being presented at a position far from the user and close to the live streaming screen in the throwable area for a virtual object, it may cause the user to not see the throwing effect clearly. Therefore, to ensure that the user can clearly and intuitively watch the throwing effect of the virtual object, the present disclosure may set a throwing boundary facing the user in the throwable area. The throwing boundary is equivalent to a virtual wall. In response to the user throwing a virtual object in the virtual space, and the virtual object touching the throwing boundary, the virtual object does not continue to fly forward, but disappears at an intersection between the virtual object and the throwing boundary, and a corresponding throwing effect is presented.

As shown in FIG. 10(A) and FIG. 10(B), the throwing boundary in the throwable area may be located at a position at a small distance from the user, and the height of the throwing boundary may be consistent with that of the live streaming screen, to ensure the integrity of the boundary in the throwable area.

It can be learned from the foregoing content that after the user performs a corresponding throw operation on any virtual object in the virtual space, a throw position of the virtual object in the virtual space may be in the following three situations:

In a first situation, a first landing point of the virtual object in the throwable area. That is, the virtual object falls on the ground in the throwable area to obtain the first landing point, which is used as the throw position of the virtual object in the present disclosure.

In a second situation, a second landing point of the virtual object in a designated non-throwable area in the virtual space. That is, the virtual object falls on the ground in the non-throwable area to obtain the second landing point, which is used as the throw position of the virtual object in the present disclosure.

In a third situation, an intersection point between the virtual object and the throwing boundary designated in the throwable area. That is, the virtual object does not fall on the ground in the virtual space, but touches the throwing boundary in the throwable area during a throwing process. Then, the intersection point where the virtual object touches the throwing boundary is located in the throwable area, and is used as the throw position of the virtual object in the present disclosure.

For the determined throw position of the virtual object in the virtual space, it can be determined whether the throw position is located in the throwable area to determine whether the current throw in the virtual space can be successfully performed. In response to the throw position being located in the throwable area, it indicates that the current throw can be successfully performed. Therefore, a throwing effect of the virtual object is presented in the virtual space. The throwing effect may be a throwing effect of throwing the virtual object into the virtual space by using the hand model, or may be an effect of sending the virtual object into the virtual space by using the throwing prop.

However, in response to the throw position being located in the non-throwable area, it indicates that the current throw cannot be successfully performed. Therefore, the virtual object is controlled to be folded back to an original position of the virtual object in the virtual space after the virtual object is presented in the virtual space for an expected duration. In other words, in response to the current throw being not successfully performed, to respond to the throw operation of the virtual object, the present disclosure also controls the virtual object to be presented in the virtual space for a short period of time. After the presentation duration of the virtual object reaches the expected duration, the throwing effect representing successful throwing is not played, but the virtual gift is controlled to be folded back to the original position of the virtual gift in the virtual space from the virtual space, to indicate that the current throw of the user is not successful.

In addition, in response to the throwing effect of the virtual object being presented in the virtual space, considering that the virtual object is thrown in a three-dimensional space and there is a corresponding space throwing trajectory, the throwing effect of the virtual object may comprise but is not limited to: the space throwing trajectory of the virtual object in the virtual space, and a throwing effect set based on the space throwing trajectory and/or the virtual object. The throwing effect may be an animation effect displayed at a final throwing point after the throwing is completed.

According to the technical solution provided in the embodiments of the present disclosure, in response to a throw operation on any virtual object in the virtual space, a throw position of the virtual object in the virtual space is first determined. Then, a throwing effect of the virtual object is presented in the virtual space based on the throw position and a designated throwable area in the virtual space, thereby ensuring the intuitiveness and accuracy of throwing the virtual object in the virtual space, and enhancing the interactivity and interest of the virtual object and a user interaction atmosphere in the virtual space, and motivating the enthusiasm for live streaming of users in the virtual space.

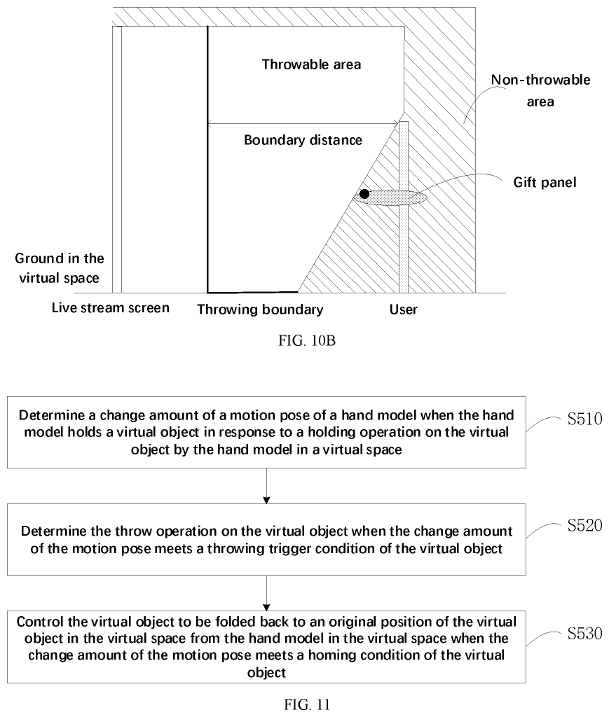

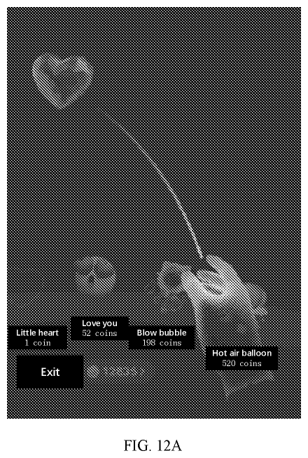

As some embodiments in the present disclosure, for a throw operation on any virtual object in the virtual space, as shown in FIG. 11, the present disclosure may describe a process of throwing any virtual object in the virtual space by using the following steps:

S510: Determine a change amount of a motion pose of a hand model holding a virtual object in response to a holding operation on any virtual object by the hand model in a virtual space.

In the present disclosure, to increase interactive operations of a user throwing a virtual object in the virtual space, and to avoid single interaction for throwing any virtual object by using a handle cursor and a Trigger key, the user may control, by using handle operations or gesture operations, a hand model simulated in the virtual space to perform corresponding motions, to perform a corresponding holding operation on any virtual object.

Then, to enhance a user interaction atmosphere for throwing any virtual object in the virtual space, it is required that after holding any virtual object, the hand model can perform some motions related to indicating throwing in the virtual space, to simulate an actual throwing process and to enhance diversified interaction for throwing the virtual object in the virtual space.

Therefore, in response to the holding operation on any virtual object by the hand model, the user may be supported to input some motion information for indicating a specific motion performed by the hand model into the XR device, for example, operating various direction buttons on a handle to control the handle to perform a corresponding motion, or controlling a hand to perform a corresponding gesture, etc., all of which may represent the motion that needs to be performed by the hand model after holding any virtual object. According to such motion information, a motion instruction initiated by the user for the hand model can be generated.

Furthermore, by parsing the motion instruction initiated by the user for the hand model, various motion information that actually needs to be performed after the hand model holds the virtual object can be determined, to control the hand model to hold the virtual object and perform a corresponding motion in the virtual space. Moreover, during an actual motion process of the hand model in the virtual space, the present disclosure also needs to determine, in real time, a change amount of a motion pose of the hand model after holding the virtual object, to determine whether the change amount of the motion pose meets a throwing trigger condition of the held virtual object.

In addition, for a throw position of the virtual object in the virtual space, after determining the change amount of the motion pose of the hand model holding the virtual object, the present disclosure may determine a throw trajectory of the virtual object in the virtual space based on the change amount of the motion pose; and determine the throw position of the virtual object in the virtual space based on the throw trajectory.

In other words, by analyzing the change amount of the motion pose performed by the hand model after holding the virtual object, information such as a motion direction and a motion speed of the virtual object in the virtual space driven by the hand model can be determined. Then, based on the information such as the motion direction and the motion speed represented by the change amount of the motion pose, a motion trajectory that can still be performed by the virtual object under the effect of motion inertia after the virtual object is released from being held by the hand model is determined, and is used as the throw trajectory in the present disclosure. Furthermore, the throw position of the virtual object in the virtual space can be determined according to the throw trajectory.

S520: Determine the throw operation on the virtual object in response to the change amount of the motion pose meeting a throwing trigger condition of the virtual object.

To ensure accurate throwing of the virtual object in the virtual space, the present disclosure may preset a throwing trigger condition for an actual throw operation of any virtual object on the virtual object.

In the present disclosure, virtual objects in the virtual space may be divided into two types: a throwable object and a non-throwable object, to enhance the diversity of throwing virtual objects in the virtual space. The throwable object may be some virtual objects that can be successfully sent to a streamer by the hand model through direct throwing in the virtual space, for example, a separate emoji gift, a heart-shaped gift, and the like. The non-throwable object may be another virtual object that is stored in a corresponding throwing prop and needs to perform a corresponding interactive operation by using the hand model and the held throwing prop, and that can be successfully thrown to the streamer, for example, a bubble gift given through a bubble stick, a hot-air balloon launched through a heating device, and the like.

In some implementations, for the throwable object in the virtual objects, a throwing trigger condition of the throwable object may be set as follows: The hand model is in a holding cancel pose after performing one throwing motion or a continuous throwing motion. In other words, whether the hand model has performed one throwing motion or a continuous throwing motion is determined based on the change amount of the motion pose performed by the hand model after holding the throwable object. Moreover, after the foregoing motion is performed, whether the holding of the throwable object is canceled to make the hand model be finally in the holding cancel pose is determined. If the throwing trigger condition of the throwable object is met, it indicates that the held virtual object is thrown into the virtual space by using the hand model, that is, it indicates that a corresponding interactive operation on the throwable object needs to be performed for the streamer in the virtual space.

In some other implementations, for the non-throwable object in the virtual objects, a throwing trigger condition of the non-throwable object may be set as follows: A target part of the hand model that interacts with the throwing prop performs a throwing operation set for the throwing prop. In response to the hand model holding the non-throwable object, it indicates that the hand model holds a throwing prop used for storing the non-throwable object. For example, for a bubble gift given through a bubble stick, the hand model holds the bubble stick from the gift panel to give a corresponding bubble gift. Then, whether the target part of the hand model that interacts with the throwing prop performs the throwing operation set for the throwing prop is determined based on the change amount of the motion pose performed by the hand model after holding the non-throwable object. If the throwing trigger condition of the non-throwable object is met, it indicates that the non-throwable object in the throwing prop can be sent into the virtual space through corresponding interaction between the target part of the hand model and the throwing prop, that is, it indicates that a corresponding interactive operation on the non-throwable object needs to be performed for the streamer in the virtual space.

As some embodiments in the present disclosure, after determining the change amount of the motion pose performed by the hand model after holding the virtual object, the present disclosure first determines the throwing trigger condition of the held virtual object. Then, whether the change amount of the motion pose performed by the hand model after holding the virtual object meets the throwing trigger condition of the virtual object is determined, to determine whether the virtual object needs to be thrown to the streamer in the virtual space. In response to the change amount of the motion pose meeting the throwing trigger condition of the held virtual object, it indicates that the user instructs to throw the virtual object to the streamer, and the throw operation on the virtual object is determined.

A throwing effect of the virtual object may then be presented in the virtual space in response to the throw operation on the virtual object, based on the throw position of the virtual object in the virtual space and the throwable area in the virtual space.

It should be noted that when the corresponding virtual object is thrown to the streamer in the virtual space by using the hand model, one throwing operation or a continuous throwing operation may be performed, so that there are different throwing types of the virtual gift. Therefore, when presenting the throwing effect of the virtual object in the virtual space, the present disclosure further determines, based on the change amount of the motion pose of the hand model after holding the virtual object, whether the motion performed by the hand model is one throwing or continuous throwing, to determine a throwing type of the virtual object. Then, a throwing effect of the virtual object in a corresponding throwing type may be presented in the virtual space.

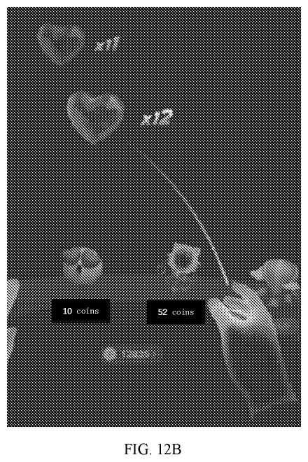

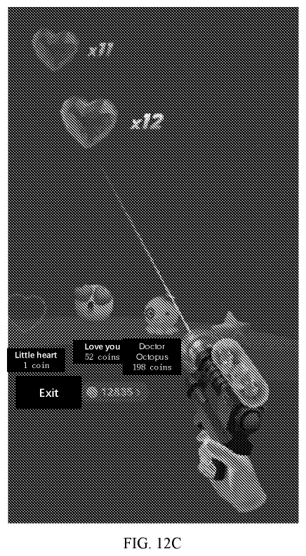

For example, the thrown virtual object is any virtual gift, FIG. 12(A) may represent an effect in response to one virtual gift being thrown in the virtual space by using the hand model, FIG. 12(B) may represent an effect in response to a plurality of virtual gifts being continuously thrown in the virtual space by using the hand model, and FIG. 12(C) may represent an effect in response to the hand model holding a gift giving prop and the gift giving prop continuously giving a plurality of virtual gifts in the virtual space.

In addition, to ensure the interactivity and interest of throwing the virtual object in the virtual space, in response to interacting with any virtual object in the virtual space by using the hand model, the present disclosure may control an XR device to perform vibrations of different degrees based on different interactive operations performed by the hand model for the virtual object. For example, in response to the hand model hovering over a specific virtual object, the XR device (for example, a real handle) is controlled to perform a mild vibration. In response to the hand model clicking the virtual object, the XR device may be controlled to perform a strong vibration. The virtual object that interacts with the hand model may be a gift entry, a gift panel, each virtual gift in the gift panel, a related user interaction control, or the like.

For example, in response to any virtual gift in the gift panel being hovered over by the hand model, the XR device may be controlled to perform a mild vibration. In response to the virtual gift being held by the hand model, the XR device may be controlled to perform a strong vibration.

When any virtual object is thrown in the virtual space, there may be a case where the virtual object is thrown in the virtual space unsuccessfully due to reasons such as insufficient throwing distance, a wrong throwing area, a network problem, or the like. Then, in response to the corresponding throwing effect is presented in the virtual space, the present disclosure further detects, in real time, whether the virtual object is thrown successfully. If the virtual object is thrown in the virtual space unsuccessfully, but the virtual object is thrown into the virtual space for the streamer. Therefore, the present disclosure may control the virtual object to be folded back to an original position of the virtual object in the virtual space from the virtual space.

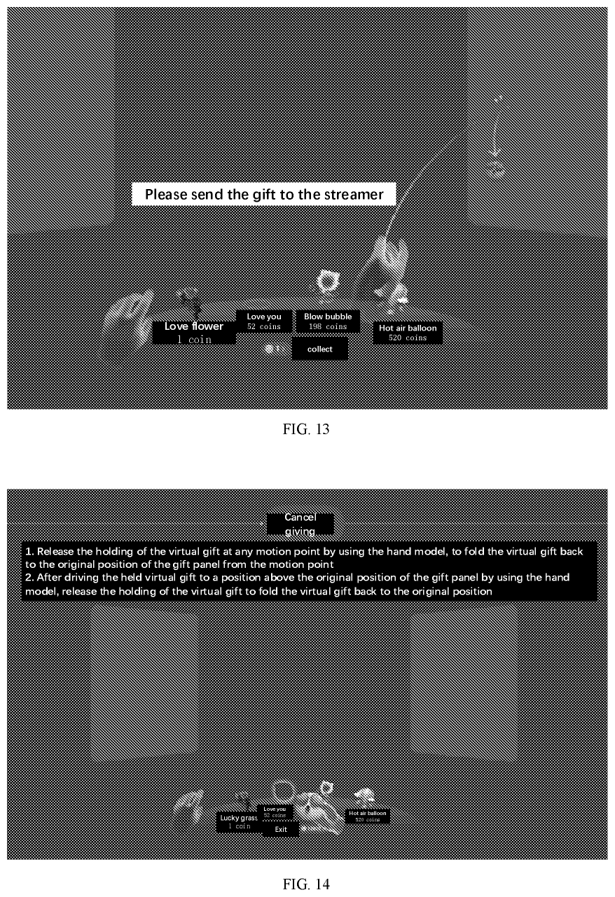

In addition, after the throwing effect of the virtual object is presented in the virtual space, it is considered that there are still various virtual objects such as a public screen and a control screen in the virtual space. Therefore, after any virtual object is thrown in the virtual space, there may be a case where the virtual object collides with any other virtual object. In response to the virtual object colliding with any other virtual object in the virtual space, the present disclosure may present a collision effect of the virtual object in the virtual space. For example, the thrown virtual object is an elastic ball and collides with the public screen in the virtual space, as shown in FIG. 13, the collision effect may be set as a rebound effect, so that the elastic ball rebounds after colliding with the public screen and then disappears in the virtual space. Moreover, after the virtual gift represented by the elastic ball collides with the public screen and it is indicated that the virtual gift is thrown in the virtual space unsuccessfully, a throwing failure prompt “Please send the gift to the streamer” is presented in the virtual space, to notify the user to re-perform a throwing operation in the virtual space and give the gift again, to ensure the success rate of giving the gift in the virtual space.

S530: Control the virtual object to be folded back to the original position of the virtual object in the virtual space from the hand model in the virtual space in response to the change amount of the motion pose meeting a homing condition of the virtual object.

After the hand model holds any virtual object and drives the virtual object to perform a corresponding motion in the virtual space, there may be a case where the user actively gives up throwing the virtual object to the streamer. In this case, in response to the user actively giving up throwing the virtual object to the streamer, the hand model releases the holding of the virtual object before the held virtual object is thrown to the streamer, to represent that the user actively gives up throwing the virtual object. Therefore, the present disclosure may set a homing condition by determining whether the hand model releases the holding of the virtual object in response to a corresponding throw operation being not performed.

Furthermore, after determining the change amount of the motion pose of the hand model holding the virtual object, the present disclosure may determine whether the change amount of the motion pose meets the homing condition of the virtual object, to determine whether the user actively gives up throwing the virtual object. In response to the change amount of the motion pose representing that the hand model releases the holding of the virtual object without performing an operation of throwing the virtual object, it indicates that the change amount of the motion pose meets the homing condition of the virtual object. Therefore, in the virtual space, the virtual object that is no longer held by the hand model may be controlled to be folded back to the original position of the virtual object in the virtual space from a position where the hand model is located.

As some embodiments in the present disclosure, considering that the hand model releases the holding of the virtual object, as shown in FIG. 14, there may be the following two situations: 1) The hand model directly releases the holding of the virtual object at any motion point after performing a corresponding motion, that is, the hand model performs an operation of releasing the holding of the virtual object at the motion point after performing the corresponding motion. 2) The hand model drives the held virtual object to perform the corresponding motion and then returns to a position above the original position in the virtual space, and then releases the holding of the virtual object, that is, the hand model drives the virtual object to return to the position above the original position in the virtual space from any motion point, and then performs the operation of releasing the holding of the virtual object.

For the first situation, the present disclosure may set a first homing condition, and the first homing condition may be: The hand model performs an operation of releasing the holding of the virtual object at any motion point when holding the virtual object. In other words, the hand model moves to any motion point after holding the virtual object, and performs the operation of releasing the holding of the virtual object at the motion point. Therefore, in response to the change amount of the motion pose of the hand model holding the virtual object meeting the first homing condition, the present disclosure may control the virtual object to perform a preset vertical motion downward from the hand model, and then be folded back to the original position of the virtual object in the virtual space.

In other words, to simulate the effect of gravity on the virtual object after the virtual object is released by the hand model, the virtual object may be controlled to perform the preset vertical motion downward for a short period of time. A downward motion distance of the preset vertical motion may be determined based on a position height where the hand model releases the holding of the virtual object and a position height of the original position. Generally, the position height where the hand model releases the holding of the virtual object is greater than the position height of the original position. For example, the thrown virtual object is a virtual gift, it is assumed that a position height where the hand model releases the holding of the virtual gift is A, and a position height of the original position on the gift panel is B, then the downward motion distance of the preset vertical motion may be 0.2*(A-B). Then, after the virtual gift performs the preset vertical motion downward, the virtual gift is controlled to be folded back to the original position of the virtual gift on the gift panel.

For the second situation, the present disclosure may set a second homing condition, and the second homing condition may be: The hand model performs an operation of releasing the holding of the virtual object after holding the virtual object and moving to a position above the original position of the virtual object in the virtual space. In other words, the hand model moves to a position above the original position in the virtual space after holding the virtual object, and performs the operation of releasing the holding of the virtual object at the position above the original position. Therefore, in response to the change amount of the motion pose of the hand model holding the virtual object meeting the second homing condition, the present disclosure may control the virtual object to be folded back to the original position in the virtual space from the current position.

In other words, in response to the hand model driving the virtual object to return to a position above the original position of the virtual object in the virtual space, the virtual object that is no longer held may be directly controlled to be folded back to the original position of the virtual object in the virtual space from the current position above the original position.

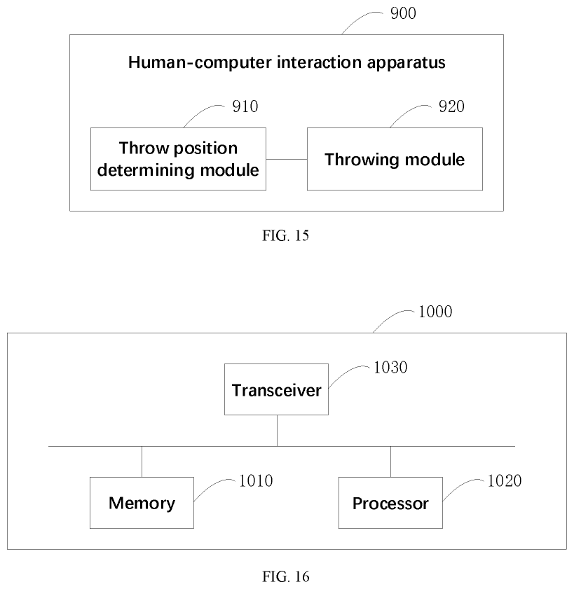

FIG. 15 is a schematic diagram of a human-computer interaction apparatus according to some embodiments of the present disclosure. The human-computer interaction apparatus 900 may be configured in an XR device. The human-computer interaction apparatus 900 comprises:

a throw position determining module 910, configured to determine a throw position of any virtual object in a virtual space in response to a throw operation on the virtual object in the virtual space; and a throwing module 920, configured to present a throwing effect of the virtual object in the virtual space based on the throw position and a designated throwable area in the virtual space.

In some implementations, the throwing module 920 may be configured to:
present the throwing effect of the virtual object in the virtual space when the throw position is located in the throwable area; or
control the virtual object to be folded back to an original position of the virtual object in the virtual space from the virtual space after the virtual object is presented in the virtual space for an expected duration when the throw position is located in a designated non-throwable area in the virtual space.

In some implementations, the throw position of the virtual object in the virtual space comprises one of the following position points:
a first landing point of the virtual object in the throwable area;
a second landing point of the virtual object in the designated non-throwable area in the virtual space; or
an intersection point between the virtual object and a throwing boundary designated in the throwable area.

In some implementations, the virtual gift interaction apparatus 900 may further comprise:
an area dividing module, configured to determine the throwable area in the virtual space based on a user visible area in the virtual space and a preset throwable range.

In some implementations, the throwing effect of the virtual object comprises: a space throwing trajectory of the virtual object in the virtual space, and a throwing effect set based on the space throwing trajectory and/or the virtual object.

In some implementations, the throw operation on any virtual object in the virtual space is determined by a throw operation determining module. The throw operation determining module may be configured to:
determine a change amount of a motion pose of a hand model when the hand model holds a virtual object in response to a holding operation on any virtual object by the hand model in a virtual space; and
determine the throw operation on the virtual object when the change amount of the motion pose meets a throwing trigger condition of the virtual object.

In some implementations, the throw position determining module 910 may be configured to:
determine a throw trajectory of the virtual object in the virtual space based on the change amount of the motion pose; and
determine the throw position of the virtual object in the virtual space based on the throw trajectory.

In some implementations, when the virtual object is a throwable object, the throwing trigger condition of the virtual object at least comprises: The hand model is in a holding cancel pose after performing one throwing motion or a continuous throwing motion; or
when the virtual object is a non-throwable object that is assisted by a throwing prop, the throwing trigger condition of the virtual object at least comprises: A target part of the hand model that interacts with the throwing prop performs a throwing operation set for the throwing prop.

In some implementations, the human-computer interaction apparatus 900 may further comprise:
a homing module, configured to control the virtual object to be folded back to an original position of the virtual object in the virtual space from the hand model in the virtual space when the change amount of the motion pose meets a homing condition of the virtual object.

In some implementations, the human-computer interaction apparatus 900 may further comprise:
a throwing failure module, configured to control the virtual gift to be folded back to the original position of the virtual gift in the virtual space from the virtual space if the virtual object is thrown in the virtual space unsuccessfully.

In some implementations, the human-computer interaction apparatus 900 may further comprise:
a collision module, configured to present a collision effect of the virtual object in the virtual space if the virtual object collides with any other virtual object in the virtual space.

In some implementations, the human-computer interaction apparatus 900 may further comprise:
a vibration module, configured to control the XR device to perform vibrations of different degrees based on different interactive operations performed by the hand model for any virtual object in the virtual space.

In the embodiments of the present disclosure, in response to a throw operation on any virtual object in the virtual space, a throw position of the virtual object in the virtual space is first determined. Then, a throwing effect of the virtual object is presented in the virtual space based on the throw position and a designated throwable area in the virtual space, thereby ensuring the intuitiveness and accuracy of throwing the virtual object in the virtual space, and enhancing the interactivity and interest of the virtual object and a user interaction atmosphere in the virtual space, and motivating the enthusiasm for live streaming of users in the virtual space.

It should be understood that the apparatus embodiments may correspond to the method embodiments in the present disclosure, and similar descriptions may refer to the method embodiments in the present disclosure. To avoid repetition, details are not described herein again.

For example, the apparatus 900 shown in FIG. 15 may perform any of the method embodiments provided in the present disclosure. For the foregoing and other operations and/or functions of each module in the apparatus 900 shown in FIG. 15, corresponding processes of the above method embodiments are implemented. For the sake of brevity, details are not described herein again.

The foregoing describes the above method embodiments in the embodiments of the present disclosure from the perspective of functional modules with reference to the accompanying drawings. It should be understood that the functional modules may be implemented in the form of hardware, or may be implemented by instructions in the form of software, or may be implemented by a combination of hardware and software modules. For example, each step in the method embodiments in the embodiments of the present disclosure may be completed by a hardware integrated logic circuit in a processor and/or instructions in the form of software. Steps of the method disclosed in the embodiments of the present disclosure may be directly implemented as being completed by a hardware decoding processor, or may be implemented by a combination of the hardware and a software module in the decoding processor. For example, the software module may be located in a mature storage medium in the art, such as a random access memory, a flash memory, a read-only memory, a programmable read-only memory, an electrically erasable programmable memory, or a register. The storage medium is located in a memory, and the processor reads information in the memory, and completes the steps in the above method embodiments in combination with the hardware.

FIG. 16 is a schematic block diagram of an electronic device according to some embodiments of the present disclosure.

As shown in FIG. 16, the electronic device 1000 may comprise:
a memory 1010 and a processor 1020, where the memory 1010 is configured to store a computer program, and transmit program code to the processor 1020. In other words, the processor 1020 may invoke and run the computer program from the memory 1010, to implement the method in the embodiments of the present disclosure.

For example, the processor 1020 may be configured to perform the foregoing method embodiment according to an instruction in the computer program.

In some embodiments of the present disclosure, the processor 1020 may comprise, but is not limited to:
a general-purpose processor, a digital signal processor (Digital Signal Processor, DSP), an application specific integrated circuit (Application Specific Integrated Circuit, ASIC), a field programmable gate array (Field Programmable Gate Array, FPGA), or another programmable logic device, a discrete gate or transistor logic device, or a discrete hardware component.

In some embodiments of the present disclosure, the memory 1010 comprises, but is not limited to:
a volatile memory and/or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which is used as an external cache. By way of example but not limitation, many forms of RAM are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (synch link DRAM, SLDRAM), and a direct rambus random access memory (Direct Rambus RAM, DR RAM).

In some embodiments of the present disclosure, the computer program may be divided into one or more modules, the one or more modules are stored in the memory 1010, and are executed by the processor 1020 to complete the method provided by the present disclosure. The one or more modules may be a series of computer program instruction segments capable of performing specific functions, and the instruction segments are used to describe an execution process of the computer program in the electronic device 1000.

As shown in FIG. 16, the electronic device may further comprise:
a transceiver 1030, where the transceiver 1030 may be connected to the processor 1020 or the memory 1010.

The processor 1020 may control the transceiver 1030 to communicate with another device. For example, the processor 1020 may send information or data to the another device or receive information or data sent by the another device. The transceiver 1030 may comprise a transmitter and a receiver. The transceiver 1030 may further comprise an antenna, and a quantity of antennas may be one or more.

It should be understood that each component in the electronic device 1000 is connected to another component through a bus system. In addition to a data bus, the bus system further comprises a power bus, a control bus, and a status signal bus.

The present disclosure further provides a computer storage medium storing a computer program thereon. When the computer program is executed by a computer, the computer is enabled to perform the method in the method embodiment.

The embodiments of the present disclosure further provide a computer program product comprising an instruction. When the instruction is executed by a computer, the computer is enabled to perform the method in the method embodiment.

When the method is implemented by using software, the method may be implemented in a form of a computer program product in whole or in part. The computer program product comprises one or more computer instructions. When the computer program instructions are loaded and executed on a computer, the processes or functions according to the embodiments of the present disclosure are all or partially generated. The computer may be a general-purpose computer, a dedicated computer, a computer network, or another programmable device. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer or a data storage device, such as a server or a data center, that integrates one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

The foregoing descriptions are merely specific implementations of the present disclosure, but are not intended to limit the protection scope of the present disclosure. Any person skilled in the art can easily think of changes or replacements within the technical scope disclosed in the present disclosure, which shall all be encompassed within the protection scope of the present disclosure. Therefore, the protection scope of the present disclosure shall be subject to the protection scope of the claims.

1. An information interaction method, comprising:
determining a moving end point of a target message sent firstly in two or more target messages that are sent continuously;
determining a moving end point of a remaining target message in the two or more target messages based on the moving end point of the target message sent firstly; and
sending the two or more target messages based on determined moving end points of the two or more target messages.

2. The information interaction method according to claim 1, wherein the determining the moving end point of the target message sent firstly in the two or more target messages that are sent continuously comprises: randomly determining the moving end point of the target message sent firstly in a target message display space set in a virtual reality space; and/or
wherein the determining moving end point of the remaining target message in the two or more target messages based on the moving end point of the target message sent firstly comprises: randomly determining the moving end point of the remaining target message within a preset region centered on the moving end point of the target message sent firstly.

3. The information interaction method according to claim 1, wherein there is a preset position relationship between the moving end point of the remaining target message and the moving end point of the target message sent firstly.

4. (canceled)

5. The information interaction method according to claim 1, further comprising:
displaying, at a preset position of a first target message in the two or more target messages, an order identifier indicating a sending order of the first target message in the two or more target messages, after the first target message moves to a determined moving end point of the first target message.

6. The information interaction method according to claim 5, wherein a duration of continuously displaying the order identifier does not exceed a duration of continuously displaying the first target message at the moving end point of the first target message.

7. The information interaction method according to claim 1, further comprising:
displaying, at preset positions of the two or more target messages, user identifiers indicating sender information of the two or more target messages, during a sending process of the two or more target messages and/or after the two or more target messages move to the determined moving end points, displaying.

8. The information interaction method according to claim 7, wherein there are different preset position relationships between different types of target messages and the user identifiers.

9. The information interaction method according to claim 1, further comprising:
displaying a first effect associated with the two or more target messages, during a process in which the two or more target messages move to moving end points corresponding to the two or more target messages; and/or
displaying a second effect associated with the two or more target messages, after the two or more target messages move to the moving end points corresponding to the two or more target messages.

10. (canceled)

11. A human-computer interaction method, applied to an extended reality (XR) device, the human-computer interaction method comprising:
determining a throw position of a virtual object in a virtual space in response to a throw operation on the virtual object in the virtual space; and
presenting a throwing effect of the virtual object in the virtual space based on the throw position and a designated throwable area in the virtual space.

12. The human-computer interaction method according to claim 11, wherein the presenting the throwing effect of the virtual object in the virtual space based on the throw position and the designated throwable area in the virtual space comprises:
presenting the throwing effect of the virtual object in the virtual space in response to the throw position being located in the throwable area; and
controlling the virtual object to be folded back to an original position of the virtual object in the virtual space after the virtual object is presented in the virtual space for an expected duration in response to the throw position being located in a designated non-throwable area in the virtual space.

13. The human-computer interaction method according to claim 11, wherein the throw position of the virtual object in the virtual space comprises one of following position points:
a first landing point of the virtual object in the throwable area;
a second landing point of the virtual object in the designated non-throwable area in the virtual space; or
an intersection point between the virtual object and a throwing boundary designated in the throwable area.

14. The human-computer interaction method according to claim 11, further comprising:
determining the throwable area in the virtual space based on a user visible area in the virtual space and a preset throwable range.

15. The human-computer interaction method according to claim 11, wherein the throwing effect of the virtual object comprises a space throwing trajectory of the virtual object in the virtual space, and a throwing effect set based on at least one of the space throwing trajectory or the virtual object.

16. The human-computer interaction method according to claim 11, wherein the throw operation on the virtual object in the virtual space is determined by following steps:
determining a change amount of a motion pose of a hand model holding the virtual object in response to a holding operation on the virtual object by the hand model in a virtual space; and
determining the throw operation on the virtual object in response to the change amount of the motion pose meeting a throwing trigger condition of the virtual object.

17. The human-computer interaction method according to claim 16, wherein the determining the throw position of the virtual object in the virtual space comprises:
determining a throw trajectory of the virtual object in the virtual space based on the change amount of the motion pose; and
determining the throw position of the virtual object in the virtual space based on the throw trajectory.

18. The human-computer interaction method according to claim 16, wherein:
in response to the virtual object being a throwable object, the throwing trigger condition of the virtual object comprises: the hand model being in a holding cancel pose after performing one throwing motion or a continuous throwing motion; or
in response to the virtual object being a non-throwable object that is assisted by a throwing prop, the throwing trigger condition of the virtual object comprises: a target part of the hand model that interacts with the throwing prop performing a throwing operation set for the throwing prop.

19. The human-computer interaction method according to claim 16, further comprising at least one of followings:
controlling the virtual object to be folded back to an original position of the virtual object in the virtual space from a position of the hand model in the virtual space in response to the change amount of the motion pose meeting a homing condition of the virtual object;
controlling, after the throwing effect of the virtual object is presented in the virtual space, the virtual object to be folded back to the original position of the virtual object in the virtual space from the virtual space in response to the virtual object being thrown in the virtual space unsuccessfully; or
presenting, after the throwing effect of the virtual object is presented in the virtual space, a collision effect of the virtual object in the virtual space in response to the virtual object colliding with any other virtual object in the virtual space.

20. (canceled)

21. (canceled)

22. The human-computer interaction method according to claim 1, further comprising:
controlling the XR device to perform vibrations of different degrees based on different interactive operations performed by the hand model on the virtual object in the virtual space.

23. (canceled)

24. An electronic device, comprising:
at least one memory and at least one processor;
wherein the memory is configured to store program code, and the processor is configured to invoke the program code stored in the memory to enable the electronic device to perform an information interaction method according to claim 1.

25. A non-transitory computer storage medium, wherein
the non-transitory computer storage medium stores program code, and when the program code is executed by a computer device, the computer device is enabled to perform an information interaction method according to claim 1.

26. (canceled)

27. An electronic device, comprising:
at least one memory and at least one processor;
wherein the memory is configured to store program code, and the processor is configured to invoke the program code stored in the memory to enable the electronic device to perform a human-computer interaction method according to claim 9.

28. A non-transitory computer storage medium, wherein the non-transitory computer storage medium stores program code, and when the program code is executed by a computer device, the computer device is enabled to perform a human-computer interaction method according to claim 9.
